(19) United States
(12) Patent Application Publication
(10) Pub. No.: US 2025/0148287 A1
(43) Pub. Date: May 8, 2025

(54) METHOD FOR CAPTURING LONG-RANGE DEPENDENCIES IN GEOPHYSICAL DATA SETS

(71) Applicant: SHELL USA, INC., Houston, TX (US)

(72) Inventors: Satyakee SEN, Houston, TX (US); Sam Ahmad ZAMANIAN, Houston, TX (US)

(21) Appl. No.: 18/837,995

(22) PCT Filed: Feb. 27, 2023
(86) PCT No.: PCT/US2023/063309

§ 371 Date: Aug. 13, 2024

Related U.S. Application Data
(60) Provisional application No. 63/315,125, filed on Mar. 1, 2022.

(51) Int. Cl. G06N 3/084; G06N 3/0464

(52) U.S. Cl. CPC G06N 3/084; G06N 3/0464

(57) ABSTRACT

A method for capturing long-range dependencies in geo-physical data sets involves dependency-training a first backpropagation-enabled process, followed by interdependency-training the dependency-trained backpropagation-enabled process. Dependency-training computes spatial relationships for each input channel of a geophysical data set. Interdependency-training computes inter-feature and spatial relationships between each of the featurized input channels. The output conditional featurized input channels are fused to produce a combined representation of the conditional featurized input channels. The combined representation is inputted to a second backpropagation-enabled process to compute a prediction selected from the group consisting of a geologic feature occurrence, a geophysical property occurrence, a hydrocarbon occurrence, an attribute of subsurface data, and combinations thereof.

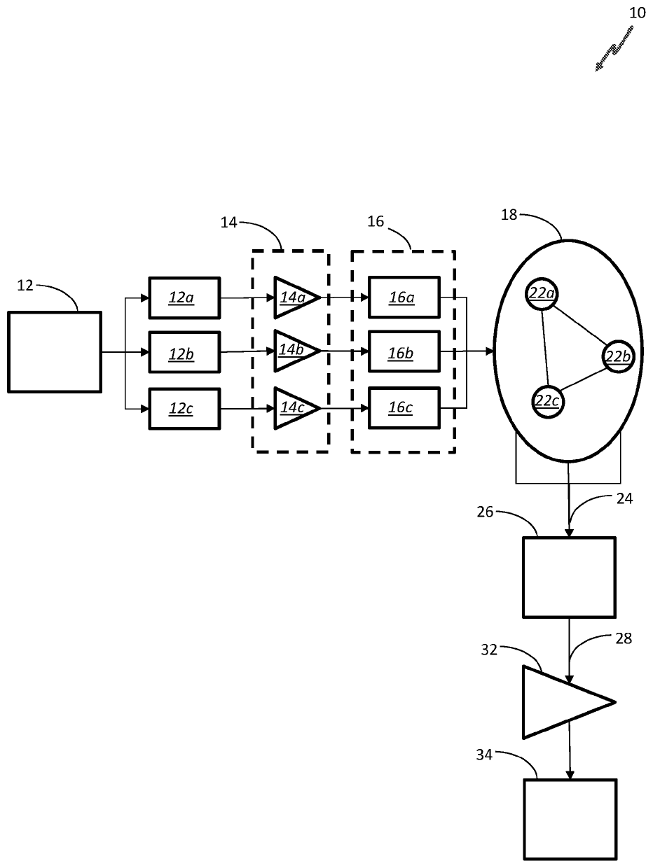

### FIELD OF THE INVENTION

The present invention relates to backpropagation-enabled processes, and in particular, to a method for capturing long-range dependencies in geophysical data sets.

### BACKGROUND OF THE INVENTION

Backpropagation-enabled machine learning processes offer the opportunity to speed up time-intensive seismic interpretation processes and interpretation of other geophysical data sets. For example, many investigators are using field-acquired seismic data for training the backpropagation-enabled processes. In such cases, investigators apply labels to identified geologic features as a basis for training the backpropagation-enabled process.

As one example, Salman et al. (WO2018/026995A1, 8 Feb. 2018) describes a method for “Multi-Scale Deep Network for Fault Detection” by generating patches from a known seismic volume acquired from field data, the known seismic volume having known faults. Labels are assigned to the patches and represent a subset of the training areas in a patch. The patch is a contiguous portion of a section of the known seismic volume and has multiple pixels (e.g., 64×64 pixels). The patch is intersected by a known fault specified by a user. A machine learning model is trained by the label for predicting a result to identify an unknown fault in a target seismic volume.

Waldeland et al. also describe using deep learning techniques for seismic data analysis in “Salt classification using deep learning” (79^{th} EAGE Conference & Exhibition, 2017, Paris, France, 12-15 Jun. 2017). As noted by Waldeland et al., deep learning on images is most often done using a group of convolutional neural networks. A group of convolutional neural networks (CNN) is a cascade of convolutions that can be used to construct attributes for solving a problem of classifying salt bodies. With a view to reducing computation time, Waldeland et al. train a CNN to classify each pixel in a dataset as either “salt” or “not salt.” The CNN is trained on one inline slice of the dataset, and the trained CNN is subsequently used to classify a different slice in the same dataset.

The results on two datasets show that salt bodies can be labelled in 3D datasets using one manually labelled slice. Waldeland et al. state that one advantage of using CNN for salt classification is that the input is just a small cube from the raw data, removing the need for attribute-engineering and making it easier to classify any given location in the dataset without computing attribute-sections. A coarse classification is done by evaluating every n-th pixel, while a more refined classification requires evaluating every pixel.

Waldeland et al. acknowledge the difficulty of working with full seismic data, which may be 3D, 4D or 5D, for producing a fully classified image. Accordingly, small cubes of input data of dimension 65×65×65 are selected from the full cube of seismic data. The goal is to have the network predicting the class of the center pixel of the small cubes. The network is trained in one manually labeled inline slice (see also Waldeland et al. “Convolutional neural networks for automated seismic interpretation” The Leading Edge 529-537; July 2018) with selected 3D cubes around the pixels in the slice. Random augmentation is applied to the training slice to simulate a larger training set by random scaling, random flipping of non-depth axes, random rotation, and random tilting.

While Waldeland et al. were motivated to reduce computational time by reducing data to center pixels of a seismic cube, the computational time actually increases significantly when a more detailed and refined classification is required, especially when it is desired to identify the occurrence of other types of subsurface features.

Griffith et al. disclose methods for training back-propagation-enabled processes to improve accuracy and efficiency, while reducing the need for computational resources. In WO2020/053197A1 (19 Mar. 2020), a backpropagation-enabled segmentation process for identifying an occurrence of a subsurface feature computes a prediction of the occurrence of the subsurface feature that has a prediction dimension of at least 1 and is at least 1 dimension less than the input dimension. In WO2020/053199A1 (19 Mar. 2020), a backpropagation-enabled regression process for identifying predicting values of an attribute of subsurface data computes a predicted value that has a dimension of at least 1 and is at least 1 dimension less than the input dimension.

A challenge for currently available backpropagation-enabled processes is the field of view in a seismic data set. Current processes look at a single pixel and the neighboring pixels. For example, for a typical seismic data set of 64×64×64 pixels, current processes have a limited field of view of 3×3×3 pixels. Achieving a wider field of view requires larger filter sizes and/or recursively applying a large number of small filters, both of which are computationally prohibitive for currently available backpropagation-enabled processes.

In a non-analogous field of machine translation, Vaswani et al. (“Attention is all you need” arXiv1706.03762; 6 Dec. 2017) indicate that, in models using convolutional neural networks as basic building blocks, the number of operations required to relate signals from two arbitrary input or output positions grows as the distance between words increases. This makes it more difficult to learn dependencies between distant word positions.

A disadvantage of the limited field of view of conventional backpropagation-enabled processes for geophysical data sets is that the context of geological structures is lost. Accordingly, current processes may not, for example, capture connections between ends of a syncline structure.

In an effort to address the need for capturing long-range dependencies, Sen (U.S. Provisional Application No. 63/216,021 filed 29 Jun. 2021) describes dependency-training a backpropagation-enabled process to compute spatial relationships between elements of a training data set, and label-training the dependency-trained backpropagation-enabled process to compute a prediction of a geophysical property occurrence, a hydrocarbon occurrence, an attribute of subsurface data, and combinations thereof.

While this greatly improves the context of a geological structure by expanding the field of view, there remains a need to further improve the capture of long-range dependencies for multiple geophysical data sets, thereby improving accuracy and efficiency of the trained process.

### SUMMARY OF THE INVENTION

According to one aspect of the present invention, there is provided a method for capturing long-range dependencies in geophysical data sets, comprising the steps of: (a) providing a training geophysical data set with a plurality of input channels, the training geophysical data set; (b) dependency-training a first backpropagation-enabled process to compute spatial relationships for each of the plurality of input channels, thereby producing a dependency-trained backpropagation-enabled process, which outputs featurized input channels for each of the plurality of input channels; (c) interdependency-training the dependency-trained backpropagation-enabled process to compute inter-feature and spatial relationships between each of the featurized input channels, thereby producing an interdependency-trained backpropagation-enabled process, which outputs conditional featurized input channels; (d) fusing the conditional featurized input channels features to produce a combined representation of the conditional featurized input channels; and (e) inputting the combined representation to a second backpropagation-enabled process to compute a prediction selected from the group consisting of a geologic feature occurrence, a geophysical property occurrence, a fluid occurrence, an attribute of subsurface data, and combinations thereof.

### BRIEF DESCRIPTION OF THE DRAWINGS

The method of the present invention will be better understood by referring to the following detailed description of preferred embodiments and the drawing referenced therein, in which:

The FIGURE is a schematic diagram of one embodiment of the present invention.

### DETAILED DESCRIPTION OF THE INVENTION

The present invention provides a method for capturing long-range dependencies in geophysical data sets using a first backpropagation-enabled process that has been trained by dependency-training for spatial relationships and interdependency-training to compute inter-feature and spatial relationships between output features of input channels. The conditional features output from the interdependency-trained backpropagation-enabled process are fused to produce a combined representation of conditional featurized input channels. The combined representation is input to a second backpropagation-enabled process to compute a prediction of a geologic feature occurrence, a geophysical property occurrence, a hydrocarbon occurrence, an attribute of subsurface data, and combinations thereof.

Analysis of subsurface data, including geophysical data, is important for improving efficiency and accuracy of hydrocarbon exploration, sites for carbon-capture and sequestration, and the like. However, geophysical data is often voluminous and subject to human error in interpretation. Moreover, the spatial relationship between spaced-apart elements of the geophysical data is often lost because backpropagation-enabled processes often have a short-range dependency, thereby restricting field of view. In other words, conventional backpropagation-enabled processes can look only at immediate neighborhood to get the statistics and/or information that it needs.

The inventors have surprisingly discovered that by first dependency-training the backpropagation-enabled process to compute spatial relationships between spaced-apart elements of a training geophysical data set, followed by interdependency-training the dependency-trained backpropagation-enabled process to compute inter-feature and spatial relationships, and then fusing the outputs of the interdependency-trained backpropagation-enabled process to produce a combined representation for training a second backpropagation-enabled process, the predictions of geologic feature occurrences, geophysical property occurrences, hydrocarbon occurrences, and/or attributes of subsurface data can be improved, thereby improving the prospectivity of the region targeted by a non-training geophysical data set.

Examples of geophysical data include, without limitation, seismic angle stacks, seismic full stack, seismic angle gathers, unmigrated seismic data, seismic velocities, well log data, borehole images, potential field data, basin model data, including, for example, vertical effective stress field and temperature volume, and combinations thereof. The geophysical data for the method of the present invention is any geophysical data, including any attributes derived therefrom, that describes the same target area.

Accordingly, the trained backpropagation-enabled process can be leveraged to predict a geologic feature occurrence, a geophysical property occurrence, a fluid occurrence, an attribute of subsurface data, and combinations thereof.

Examples of geologic features include, without limitation, boundary layer variations, overlapping beds, rivers, channels, tributaries, salt domes, basins, and combinations thereof. Geologic features also include indicators of geologic processes including, without limitation, tectonic deformation, erosion, infilling, and combinations thereof. Examples of tectonic deformation processes include, without limitation, earthquakes, creep, subsidence, uplift, erosion, tensile fractures, shear fractures, thrust faults, and combinations thereof. Geologic features may also include lithofacies, the geologic environment in which the rocks were deposited. Geologic features may also include elements of a working petroleum system such as source rocks, migration pathways, reservoir rocks, seal (a.k.a. cap rock) and trapping elements.

Examples of geophysical properties include, without limitation, elastic parameters of the subsurface (such as λ and μ), P-wave velocity, S-wave velocity, porosity, impedance, reservoir thickness, and combinations thereof

Examples of fluid occurrences include, without limitation, the occurrence of any combination of oil, gas or brine occupying the pore space of the rock matrix.

Examples of attributes of subsurface data include any quantity derived from the geophysical data such as, without limitation, spectral content, energy associated with changes in frequency bands, signals associated with filters including, without limitation, noise-free filters, low-pass filters, high-pass filters, and band-pass filters, acoustic impedance, reflectivity, semblance, loop-based properties, envelope, phase, dip, azimuth, curvature and the like.

Examples of the first and second backpropagation-enabled processes include, without limitation, artificial intelligence, machine learning, and deep learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

A preferred embodiment of a backpropagation-enabled process is a deep learning process, including, but not limited to a convolutional neural network.

Referring the FIGURE illustrating one embodiment of the method of the present invention 10, a training geophysical data set 12 has a plurality of input channels 12a, 12b, 12c. As a non-limiting, but illustrative example, the plurality of input channels 12a, 12b, 12c, may represent near-, mid-and far-geophysical data. In one non-limiting example, the near-, mid-and far-geophysical data may represent near-, mid-and far-angle stack seismic data.

A first backpropagation-enabled process 14 is trained with the geophysical data from each of the input channels 12a, 12b, 12c. The FIGURE illustrates parallel paths 14a, 14b, 14c for the backpropagation-enabled process 14.

In the parallel paths 14a, 14b, 14c, the first backpropagation-enabled process 14 is dependency-trained to compute spatial relationships for each of the input channels 12a, 12b, 12c. The output 16 of the first backpropagation-enabled process 14 is a set 16 of featurized input channels 16a, 16b, 16c for each of the input channels 12a, 12b, 12c. The featurized input channels 16a, 16b, 16c represent a data-feature selected from a geologic feature, a geophysical property, a fluid, an attribute of subsurface data, and combinations thereof for each of the input channels 12a, 12b, 12c.

The dependency-trained backpropagation-enabled process 14 is then trained by interdependency-training step 18, where inter-feature and spatial relationships are computed for data-features 22a, 22b, 22c of the featurized input channels 16a, 16b, 16c. The output 24 of the interdependency-training step 18 is a set of conditional featurized input channels 24.

In a preferred embodiment, the dependency-training and interdependency training steps are repeated.

In fusion step 26, the set of conditional featurized input channels 24 is fused to produce a combined representation 28 of the conditional featurized input channels 24. The combined representation 28 is input to a second backpropagation-enabled process 32 to compute a prediction 34 selected from the group consisting of a geologic feature occurrence, a geophysical property occurrence, a hydrocarbon occurrence, an attribute of subsurface data, and combinations thereof.

The first and second backpropagation-enabled processes may be the same or different and each may be supervised, semi-supervised, unsupervised or a combination thereof. In one embodiment, a supervised process is made semi-supervised by the addition of an unsupervised technique. In another embodiment, a subset of the geophysical data is labeled in a semi-supervised process. As an example, the unsupervised technique may be an auto-encoder step. Examples of an unsupervised backpropagation-enabled process include, without limitation, a variational autoencoder (VAE) process and a generative adversarial network (GAN) process. Examples of a semi-supervised backpropagation-enabled process include, without limitation, a semi-supervised VAE process and a semi-supervised GAN process.

In a supervised backpropagation-enabled process, the training geophysical data set is labeled to provide examples of geologic features, geophysical properties, hydrocarbons, and/or attributes of interest. In an unsupervised backpropagation-enabled process, a feature, property or attribute of interest may be identified by, for example, drawing a polygon around an image of interest in the geophysical data. The trained process will then identify areas of interest having similar latent space characteristics. When the training geophysical data set is labeled geophysical data, the labels may have a dimension of 1D-3D.

In one embodiment, the supervised backpropagation-enabled process is a classification process. The classification process may be conducted voxel-wise, slice-wise and/or volume-wise.

In another embodiment, the unsupervised backpropagation-enabled process is a clustering process. The clustering process may be conducted voxel-wise, slice-wise and/or volume-wise.

In another embodiment, the unsupervised backpropagation-enabled process is a generative process. The generative process may be conducted voxel-wise, slice-wise and/or volume-wise.

In accordance with one embodiment of the present invention, a training geophysical data set has a set of associated training labels. The training geophysical data set may have a dimension in the range of from 1 to 6. An example of a 1D geophysical data set is a seismic ribbon (for example representing a line in a 2-dimensional slice or grid, for example a line is an x or y direction), or a seismic trace (for example, an amplitude in a z-direction at an x-value). A seismic array is an example of 2D or 3D data, while pre-stack seismic response data may be 4D and/or 5D. An example of 6D data may be 5D data with time-lapse data. Seismic response data may be field-acquired and/or simulated seismic data from multiple field or simulated source locations and/or multiple field or simulated receiver locations. Seismic response data includes, for example, without limitation, single offset, multiple offsets, single azimuth, multiple azimuths, and combinations thereof for all common midpoints of field-acquired and/or simulated seismic data. 4D-6D data may also be 3D seismic data with attributes related to seismic survey acquisition or the result of multiple attribute computations. As an example, multiple attributes preferably comprise 3 color channels. The seismic response data may be measured in a time domain and/or a depth domain.

The 2D data set may, for example, be 2D geophysical data or 2D data extracted from geophysical data of 3 or more dimensions. Likewise, the 3D data set may, for example, be 3D geophysical data or 3D data extracted from geophysical data of 4 or more dimensions. And the 4D data set may, for example, be 4D geophysical data or 4D data extracted from geophysical data of 5 or more dimensions.

The training geophysical data set may be selected from real geophysical data, synthetically generated geophysical data, augmented geophysical data, and combinations thereof.

For real geophysical data, associated labels describing subsurface features in the image may be manually generated, while labels for simulated geophysical data are automatically generated. The generation of labels, especially manual label generation, is time-intensive and requires expertise and precision to produce an effective set of labels.

By augmented data, we mean field-acquired and/or synthetically generated data that is modified, for example, by conventional DL data-augmentation techniques, as described in Taylor et al. (“Improved deep learning with generic data augmentation” IEEE Symposium-Symposium Series on Computational Intelligence SSCI 2018 1542-1547; 2018) which describes conventional augmenting by geometrical transformation (flipping, cropping, scaling and rotating) and photometric transformations (amending color channels to change lighting and color by color jittering and Fancy Principle Component Analysis). Augmented data may also be generated, for example, as described in Liu et al. (US2020/0183035A1), which relates to data augmentation for seismic interpretation, recognizing that standard data augmentation strategies may produce limited plausible alternative samples and/or may lead to geologically or geophysically infeasible to implausible alternative samples. The machine learning method involves extracting patches from input data and transforming that data based on the input data and geologic and/or geophysical domain knowledge to generate augmented data. Transforming data is selected from an identity transformation, a spatial filter, a temporal filter, an amplitude scaling, a rotational transformation, a dilatational transformation, a deviatoric transformation, a resampling using interpolation or extrapolation, a spatial and temporal frequency modulation, a spectral shaping filter, an elastic transformation, an inelastic transformation, and a geophysical model transformation. In another embodiment, two pieces of data are blended together to generate a new piece of data. Other geophysical augmenting methods may also be used to generate augmented data. The labels may be preserved or modified in the augmentation. In this way, the data set size may be augmented to improve the model by introducing variations of data without requiring resources of acquiring and labeling field-acquired data or generating new synthetic data. Preferably, the augmented data is generated by a test-time augmentation technique.

The backpropagation-enabled process is dependency-trained to compute spatial relationships or connections between elements of the training geophysical data set.

The dependency-training step preferably computes spatial relationships between elements of the training geophysical data set by applying self-attention weights to the training geophysical data set.

In a preferred embodiment, the dependency-training step involves preparing a square self-attention matrix using the training geophysical data set. Where the training geophysical data set is 1D, for example, 1×N, the square self-attention matrix is preferably N×N. Where the training geophysical data set is 2D or greater, the training geophysical data set is preferably flattened to a 1D representation of the training geophysical data set, for example, 1×M, the square self-attention matrix is preferably M×M.

So, for example, where the training geophysical data set is 64×64×64, the square self-attention matrix will have a dimension of 262,144×262,144. The self-attention matrix uses an image to correlate pixels within the whole of the training geophysical data set. By providing an unrestricted field of view, long-range dependencies can be captured because the backpropagation-enabled process is allowed to make connections between inter-dependent pixels in all directions.

Preferably, at least a portion of the square self-attention matrix is populated with values defining the spatial relationships between any two elements in the square self-attention matrix. Each value represents the strength of the spatial relationship between two elements in the matrix. Preferably, the values are provided on a scale of 0-1, where 1 indicates the highest similarity.

An updated training geophysical data set is defined by combining the training geophysical data set by the scores of the self-attention matrix, preferably by performing a linear transformation of the populated square self-attention matrix with the training geophysical data set. Examples of suitable linear transformations include, without limitation, convolution, pooling, softmax, Fourier, and combinations thereof. The updated training geophysical data set preferably has a dimension equal to the training data set.

The updated training geophysical data set may be used in the next step or the steps of preparing and populating the self-attention matrix and updating the training geophysical data set may be repeated one or more times. As the dependency-training progresses, the backpropagation-enabled process with self-attention learns to put correct values in the matrix to properly capture relationships between elements. Preferably, the steps are repeated from 1 to 25 times, more preferably from 1 to 10 times, most preferably from 2 to 8 times. By repeated the steps, the strength of connections between elements is improved.

A sequence of one or more mathematical operation is executed on the updated training geophysical data. The mathematical operation may be multiplying and/or adding in any sequence. The dimension of the mathematical operation is preferably less than or equal to the training geophysical data set. The steps of preparing and populating the self-attention matrix, updating the training geophysical data set, and executing a sequence of layers may be repeated one or more times. Preferably, the steps are repeated until the prediction accuracy on the training geophysical data set exceeds 80%, preferably 85%, or until the prediction accuracy substantially plateaus or stops increasing.

The dependency-trained backpropagation-enabled process is then label-trained using the training geophysical data set and the associated training labels to compute a prediction of an occurrence and/or a value of an attribute.

The label-trained backpropagation-enabled process can now be used to capture long-range dependencies in a non-training geophysical data set. Preferably, the trained backpropagation-enabled process computes a regression prediction and/or a segmentation prediction. The prediction may be a geologic feature occurrence, a geophysical property occurrence, a hydrocarbon occurrence, and/or an attribute of subsurface data.

For example, a suitable backpropagation-enabled segmentation process is described in Griffith et al. WO2020/053197A1 (19 Mar. 2020). A suitable backpropagation-enabled regression process is described in Griffith et al. WO2020/053199A1 (19 Mar. 2020).

While preferred embodiments of the present invention have been described, it should be understood that various changes, adaptations and modifications can be made therein within the scope of the invention(s) as claimed below.

What is claimed is:

1. A method for capturing long-range dependencies in geophysical data sets, comprising the steps of:
a) providing a training geophysical data set with a plurality of input channels, the training geophysical data set;
b) dependency-training a first backpropagation-enabled process to compute spatial relationships for each of the plurality of input channels, thereby producing a dependency-trained backpropagation-enabled process, which outputs featurized input channels for each of the plurality of input channels;
c) interdependency-training the dependency-trained backpropagation-enabled process to compute inter-feature and spatial relationships between each of the featurized input channels, thereby producing an interdependency-trained backpropagation-enabled process, which outputs conditional featurized input channels;
d) fusing the conditional featurized input channels to produce a combined representation of the conditional featurized input channels; and
e) inputting the combined representation to a second backpropagation-enabled process to compute a prediction selected from the group consisting of a geologic feature occurrence, a geophysical property occurrence, a fluid occurrence, an attribute of subsurface data, and combinations thereof.

2. The method of claim 1, wherein the dependency-training and interdependency-training steps are repeated.

3. The method of claim 1, wherein the training geophysical data set has a set of associated training labels and step (e) further comprises the step of comparing the prediction to a label in the set of associated labels.

4. The method of claim 3, further comprising the steps of:
f) label-training the interdependency-trained backpropagation-enabled process using the training geophysical data set and the associated training labels to compute a prediction selected from an occurrence, a value of an attribute, and combinations thereof, thereby producing a label-trained backpropagation-enabled process; and
g) using the label-trained backpropagation-enabled process to capture long-range dependencies in a non-training geophysical data set by computing a prediction selected from the group consisting of a geologic feature occurrence, a geophysical property occurrence, a hydrocarbon occurrence, an attribute of subsurface data, and combinations thereof.

5. The method of claim 1, wherein the dependency-training step computes spatial relationships by applying self-attention weights to the training geophysical data set.

6. The method of claim 1, wherein the dependency-training step comprises the steps of:
i. preparing a square self-attention matrix using the training geophysical data set;
ii. populating at least a portion of the square self-attention matrix with values defining the spatial relationships between any two elements in the square self-attention matrix;
iii. defining an updated training geophysical data set by performing a linear transformation of the populated square self-attention matrix with the training geophysical data set; and
iv. executing one or more mathematical operation on the updated training geophysical data, wherein the dimension of the mathematical operations is less than or equal to the training geophysical data set.

7. The method of claim 6, further comprising the step of repeating steps i-iii.

8. The method of claim 6, further comprising the step of repeating steps i-iv.

9. The method of claim 6, wherein the linear transformation is selected from the group consisting of convolution, pooling, softmax, Fourier, and combinations thereof.

10. The method of claim 6, wherein the mathematical operation is selected from the group consisting of multiplying, adding, and combinations thereof.

11. The process of claim 1, wherein the prediction is a regression prediction computed by computing a predicted value of the attribute, wherein the predicted value has a prediction dimension of at least 1 and is at least 1 dimension less than the input dimension.

12. The process of claim 1, wherein the prediction is a segmentation prediction computed by computing a prediction of the occurrence of one or more of a geologic feature, a geophysical property and a hydrocarbon, wherein the prediction has a prediction dimension of at least 1 and is at least 1 dimension less than the input dimension.

13. The method of claim 1, wherein the geologic feature occurrence is selected from the group consisting of occurrences of a boundary layer variation, an overlapping bed, a river, a channel, a tributary, a salt dome, a basin, an indicator of tectonic deformation, an indicator of erosion, an indicator of infilling, a geologic environment in which rocks were deposited, a source rock, a migration pathway, a reservoir rock, a seal, a trapping element, and combinations thereof.

14. The method of claim 1, wherein the geophysical property occurrence is selected from the group consisting of occurrences of an elastic parameter, a P-wave velocity, an S-wave velocity, a porosity, an impedance, a reservoir thickness, and combinations thereof.

15. The method of claim 1, wherein the fluid occurrence is selected from the group consisting of occurrences of oil, gas, brine, and combinations thereof.

16. The method of claim 1, wherein the attribute of subsurface data is selected from the group consisting of quantities of spectral content, energy associated with changes in a frequency band, a signal associated with a filter, an acoustic impedance, a reflectivity, a semblance, a loop-based property, an envelope, a phase, a dip, an azimuth, a curvature, and combinations thereof.

17. The method of claim 1, wherein one or both of the first backpropagation-enabled process and the second backpropagation-enabled process is a deep learning process.

18. The method of claim 1, wherein one or both of the first backpropagation-enabled process and the second backpropagation-enabled process is a supervised regression process, comprising the step of comparing attributes computed in a conventionally computed technique with the ones from a supervised regression technique.

19. The method of claim 1, wherein the first backpropagation-enabled process and the second backpropagation-enabled process are each independently selected from the group consisting of supervised, semi-supervised, unsupervised processes and combinations thereof.

20. The method of claim 1, wherein the training geophysical data set is comprised of geophysical data selected from the group consisting of real geophysical data, synthetically generated geophysical data, augmented geophysical data, and combinations thereof.
